(19) United States
(12) Patent Application Publication
(10) Pub. No.: US 2008/0272009 A1
(43) Pub. Date: Nov. 6, 2008

(54) Systems and Methods for Identifying Expiration of a Secondary Contact Lens Case

(76) Inventor: Jonathan C. Coon, Salt Lake City, UT (US)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 11/840,400

(22) Filed: Aug. 17, 2007

Related U.S. Application Data
(60) Provisional application No. 60/927,203, filed on May 1, 2007.

(51) Int. Cl. A45C 11/04; B65D 85/00; B65D 41/04; B23P 19/04

(52) U.S. Cl. 206/5.1; 206/459.1; 220/288; 29/700

(57) ABSTRACT

Secondary case for a contact lens includes an indicator on the secondary case that indicates when the secondary contact lens case is expired. The indicator may include any number of features such as a month indicator, pictures related to the seasons, numbers, shapes, colors, dates, time periods, or a time sensitive reactive ink.

### RELATED APPLICATIONS

The present application claims the benefit under 35 U.S.C. §119(e) of U.S. Provisional Patent Application No. 60/927,203 filed May 1, 2007 titled “Systems and Methods for Identifying Expiration of a Secondary Contact Lens Case”, which application is incorporated herein by reference in its entirety.

### BACKGROUND

Contact lenses are small lenses that are worn directly on the eye and are widely used to correct vision problems. Contact lenses have traditionally been either rigid (hard) or soft. One important consideration in wearing contact lenses is eye health. Because contact lenses are placed directly on the eye, it is important that they not introduce any unwanted contamination or other foreign object into the eye.

The more commonly used soft contact lenses are designed to be used for a specified number of days, and are then to be replaced. For example, many contact lenses are to be used for up to 14 days, after which they are to be disposed of. This routine replacement of soft contact lenses is highly desirable because it is difficult for a patient to sterilize or otherwise adequately clean the inevitable contamination that builds up on the lenses over time.

Another aspect of contact lens health deals with the storage of a patient's contact lenses when they are not being used. Contact lens wearers typically have a secondary case to store a currently used set of contact lenses when they are not being worn, such as when the wearer is sleeping. As used herein, the term secondary case shall be interpreted to mean any container or receptacle configured to store a previously used contact lens when not in use. The storage container should enable the wearer to store the lenses in a suitable hydrating and anti-microbial solution and thus must be resealable. A typical contact lens storage case has two compartments that are marked or fashioned in some way in order to differentiate the right and left compartments. This marking is performed because wearers often need a different prescription to correct the vision in their left eye compared to the prescription to correct the vision in their right eye. Consequently, traditional storage cases provide a means for the user to remember which contact lens is made for which eye after storage, as it is difficult to distinguish one contact lens from the other with the naked eye, especially for someone with diminished optical capacity.

One issue of optical health that has not been heretofore addressed is the need to replace contact lens storage cases frequently. Even though many wearers realize that they need to dispose of lenses after the recommended wearing period, they do not realize that their lens storage case also have a recommended use period. Over time these storage cases can build up contaminants and become a breeding ground for microbes, even though the lens case is rinsed out each morning after the contact lenses are removed and placed in the wearer's eyes. It is highly recommended that secondary contact lens cases be replaced as frequently as every 30 days.

Another issue faced by contact lens wearers is keeping track of how long a current secondary lens storage case has been used. For many people the acceptable period of time for using a single secondary storage case passes without notice or concern regarding the sanitation of the secondary case. As a result, a person must either make a note on a calendar, a PDA, or somewhere else and constantly refer to the note, or they lose track of when they last started using the current secondary case and either dispose of it earlier than necessary or later than they should.

### SUMMARY

The secondary lens case for a contact lens includes an expiration indicator on the secondary case that indicates when the safe or useful life of the secondary case has expired.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the claims.

FIG. 1 illustrates a traditional secondary contact lens case, according to the teachings of the prior art.

FIG. 2 illustrates a traditional secondary contact lens case, according to the teachings of the prior art.

FIGS. 3A and 3B illustrate a traditional secondary contact lens case, according to the teachings of the prior art.

FIG. 4 is a top view illustrating a secondary contact lens case including an expiration indicator, according to one exemplary embodiment.

FIGS. 5A and 5B illustrate a bottom view and a partially assembled top view, respectively of a secondary contact lens case including an expiration indicator, according to one exemplary embodiment.

FIG. 6 illustrates a partially assembled frontal view of a secondary contact lens case including an expiration indicator, according to one exemplary embodiment.

FIGS. 7A and 7B illustrate a top view and a side view, respectively of a snap top secondary contact lens case including an expiration indicator, according to one exemplary embodiment.

FIG. 8 illustrates a top view of a secondary contact lens case including an expiration indicator, according to one exemplary embodiment.

FIG. 9 illustrates a side exploded view of a secondary contact lens case including an expiration indicator, according to one exemplary embodiment.

FIG. 10 is a perspective view of a package containing a year supply of secondary contact lens cases including expiration identifiers, according to one exemplary embodiment.

FIG. 11 is a frontal view of a package containing a year supply of secondary contact lens cases including expiration identifiers, according to one exemplary embodiment.

Throughout the drawings, identical reference numbers designate similar, but not necessarily identical, elements.

### DETAILED DESCRIPTION

The present specification describes systems and methods for providing an expiration indicator to convey to a user when a secondary contact lens case has expired and should be disposed of. According to one exemplary embodiment, the secondary contact lens case includes an identifier including, but in no way limited to at least one letter of a month, a color, an image, or a shape formed or attached to the secondary contact lens case to remind a user when the secondary contact lens case is no longer safe to use. Consequently, the contact lens wearer will remember to frequently dispose of his or her secondary contact lens case and will benefit from improved ocular health. Further details of the present exemplary systems and methods will be provided below with reference to the figures.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

As used herein and in the appended claims, the term “primary package,” “primary packaging,” or “primary case” will be used to refer to the packaging in which a contact lens or a supply of lenses are placed during the manufacturing processes and the packaging in which the lens or supply of lenses is then provided either directly to a lens wearer or to a contact lens supplier, a dispensing optometrist, or other eye care professional. Similarly, the term “secondary case,” “secondary contact lens case” and “secondary package” shall be used interchangeably and shall be interpreted broadly as including any container or packaging that a lens may be placed in subsequent to being received and or used by the lens wearer, such as a lens container in which the lenses are stored or cleaned during the period they are in service and after having been removed from the primary packaging of the manufacturer. If, however, the lenses are repackaged commercially before being provided to a lens wearer, that repackaging shall still be considered “primary packaging” as defined herein.

FIG. 1 illustrates an exemplary traditional secondary contact case (100) as known in the prior art. The secondary contact case (100) includes a generally flat bridge (105), two bottom members (110), and two caps (115). The bridge (105) and bottom members (110) may be formed as one unitary member. The bridge (105) is generally flat and extends between the two bottom members (110) to provide stability to the case (100). The bottom members (110) have a well (120), and a wall rising above the well and ending in a top rim (125) defining an opening to the bottom members (110). The wells (120) may be hermetically sealed by threading the caps (115) onto the bottom members (110). The bottom members (110) include engagement threads (130) formed on the outer surface of the bottom members which engage with inner engagement threads (not shown) formed on an inner surface of the cap (115) to secure the cap (115) to the bottom members (110) and to provide a hermetic seal.

As illustrated in FIG. 1, the caps (115) of the illustrated traditional secondary contact lens case (100) contain the identifiers “R” (135) and “L” (140) to identify which well (120) is intended to receive and house the right and left contact lenses. The bottom members (110) and caps (115) are preferably made of a high quality polypropylene free of additives. It is also possible to use other polymers, particularly polyolefins, such as high density polyethylene (HDPE) or other materials familiar to those in the art to make the bottom members (110) and caps (115).

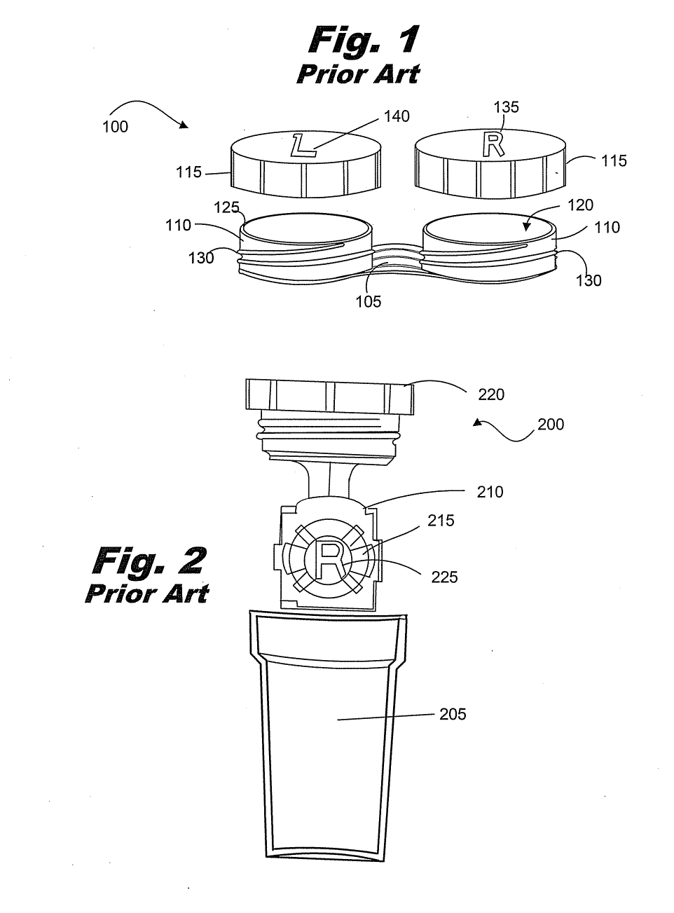

FIG. 2 illustrates another traditional secondary contact lens case (200) known in the prior art that includes a container (205), a cap (220), a contact lens holder (210) and two closable baskets or cages (215) into which contact lenses can be placed. These baskets (215) may be marked with identifiers (225) specifying which basket (215) is intended to house the right or left contact lenses. In this configuration, the closable baskets (215) are attached to the contact lens holder (210) which in turn is affixed to the bottom of the cap (220) such that when the cap (220) is screwed onto the top of the contact lens container (205), the baskets (215) are enclosed by the container (205). A cleaning solution may be placed in the container (205) so that when the contact lenses are placed in the baskets (215) and the cap (220) is screwed into place, the contact lenses are submersed in the cleaning solution.

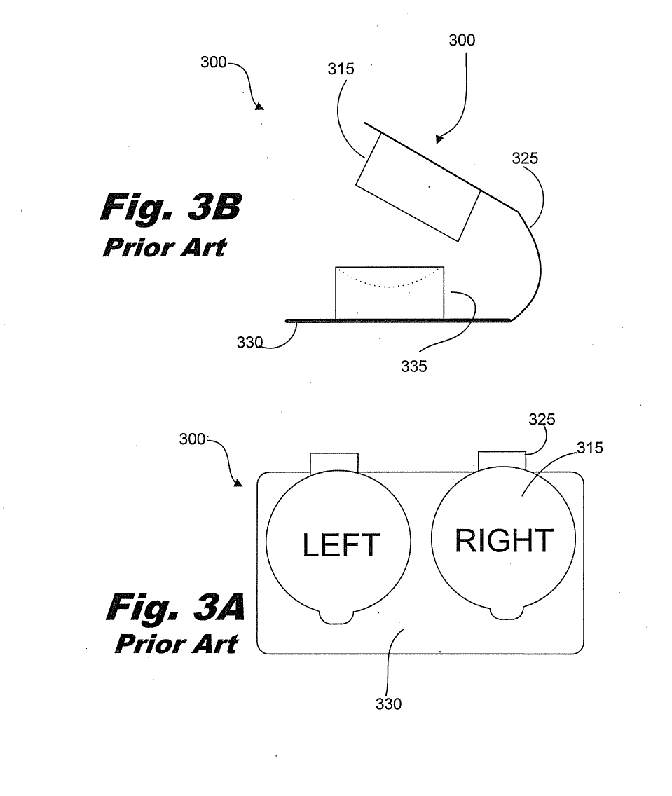

FIGS. 3A and 3B are a top and side view, resepectively, of yet another traditional secondary contact lens case (300), as is known in the art. The illustrated configuration has a base (330) that extends outwardly from the bottom members (335) to provide stability to the case (300). The known configuration also utilizes caps (315) with an interference type design that utilizes a snap-on fit to secure the caps to the bottom members (335) and to provide a leak-proof closure. Additionally, a flexible strap (325) often connects the caps (315) to the base (330). Alternatively the strap (325) could connect the caps (315) to the bottom members (335).

As mentioned previously, the traditional secondary contact lens cases illustrated in FIGS. 1 through 3B fail to notify or otherwise motivate a user to dispose of the lens case when its recommended life has expired. Consequently, ocular health and contact lens comfort are often compromised.

According to one of many exemplary embodiments described herein, a secondary contact lens case is provided to notify or otherwise motivate a contact lens wearer to dispose of their secondary contact lens case when its recommended life has expired. Specifically, according to one exemplary embodiment, the present secondary contact lens case includes a base defining at least one well configured to receive and store a contact lens during an extended time period, such as overnight, when the contact lens is not being used by a wearer. Additionally, a hermetically sealing cap can be configured to engage the at least one defined well. Similar to traditional secondary cases, the hermetically sealing cap is configured to cover the at least one defined well and form a hermetic barrier to prevent contamination from entering the defined well. According to the present exemplary embodiment, the secondary contact lens case also includes a specific feature configured to remind, encourage or otherwise motivate a user to dispose of the secondary contact lens case when the recommended life of the secondary contact lens case has expired. Particularly, according to one exemplary embodiment, the particular feature is configured to remind the user to dispose of and replace their secondary contact lens case monthly, or approximately every 30 days. Various features and embodiments of the present exemplary secondary contact lens case including expiration indicators will be provided in detail below with reference to FIGS. 4 through 11.

FIG. 4 illustrates a secondary contact case (400) including expiration indicators as seen from above, according to one exemplary embodiment. As illustrated in FIG. 4, the exemplary secondary contact lens case (400) includes an indicator (405) configured to remind the user to dispose of the secondary contact lens case frequently. According to one exemplary embodiment, the indicator (405) configured to remind the user to dispose of the secondary contact lens case includes a number from 1 through 12 that corresponds to the month following which the case should be discarded. As illustrated in FIG. 4, a secondary contact lens case (400) is provided including an indicator (405) in the form of the number five. According to this exemplary embodiment, the number five on the secondary contact lens case indicates that the case should be used during the fifth month of the year, or the month of May.

Alternatively the indicator (405) disposed on the secondary contact lens case (400) could include one or more letters of a selected month, rather than the number of the month. Furthermore, any number of other indicators may be used to remind a user to dispose of their secondary contact lens storage case (400) frequently, such as monthly. For example, according to one exemplary embodiment, the indicators (405) may include, but are in no way limited to, pictures or shapes related to the various seasons or holidays associated with each month such as snowmen, snowflakes, presents, Christmas trees, dreidels, etc. for winter, fall leaves, turkeys, jack-o-lanterns, footballs, etc. for fall, flowers, hearts, shamrocks, raindrops, etc. for spring, sunshine, firecrackers, etc. for summer; shapes; colors; dates such as the first date of each month; or a statement such as “expires 30 days from first use” or “good for 30 days.”

Additionally, the indicator (405) may be formed on any number of convenient locations on the secondary contact lens storage case (400) or by any number of formation methods. For example, FIG. 4 illustrates the indicator (405) is formed on top of the hermetically sealing cap (415) for visibility. The indicator (405) may be integrally formed or molded on the cap (415) as a feature of a mold or a second step in a two-shot mold. Alternatively, the indicator (405) may be formed on the hermetically sealing cap (415) post manufacture by any number of methods including, but in no way limited to, a sticker, inkjet printing, laser printing, etc. In some instances this indicator may replace the letter (410) or indicator (410) that indicates which side a contact is supposed to be stored in. This replacement will not disadvantage the user as only one side need be labeled in this way in order for the user to place the contacts in the appropriate side and subsequently retrieve the proper lens during re-insertion into the eye.

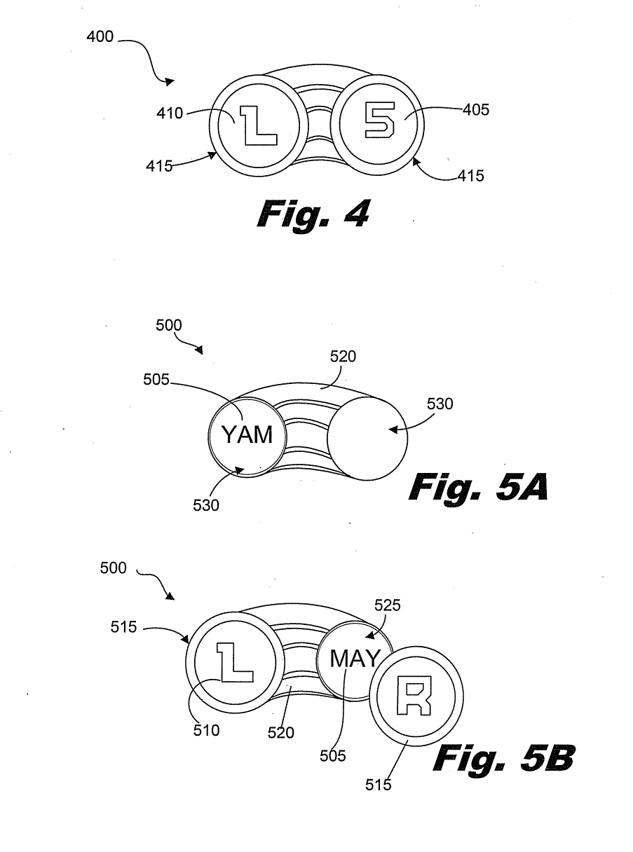

According to another exemplary embodiment, as shown in FIGS. 5A and 5B, the month indicator (510) can be formed on the bottom side of the base (530), wherein the base (530) is made from a substantially transparent material. According to this exemplary embodiment, the month indicator (505) is molded or formed in reverse orientation so that when a user places their contact lens in the well (525), the reminder (505) will be viewed in its proper orientation. The indicator (505) in this embodiment may be located under one or both wells (525), and/or under the bridge (520) connecting the two wells (525).

FIG. 5A illustrates a bottom view of an exemplary case (500) with a substantially transparent base (530) and reversed indicator lettering (505). In the illustrated exemplary embodiment, the indicator (505) includes the name of a month. However, in alternative embodiments, the indicator (505) could be, but is in no way limited to, a number, a letter, a statement, a symbol, or a device which would remind the user to properly replace the secondary contact lens case (500). This indicator (505) may be formed, or molded on the bottom side of the case during initial manufacturing either with a single shot mold or a two-shot mold. Alternatively, the indicator (505) may be formed post manufacture by any number of methods including, but in no way limited to, a sticker, inkjet printing, laser printing, and the like.

FIG. 5B shows the top view of the exemplary embodiment depicted in FIG. 3A. This view shows how the indicator (505) may be seen through the substantially transparent base (530) once the cap (515) is removed. Although in the depicted embodiment the indicator (505) is found underneath the right well (525), in other embodiments the indicator (505) may be placed under either or both wells (525) and/or under the bridge (520) connecting the two wells. As discussed above, this indicator (505) may take any number of forms including numbers, symbols, letters, words, shapes, and/or colors.

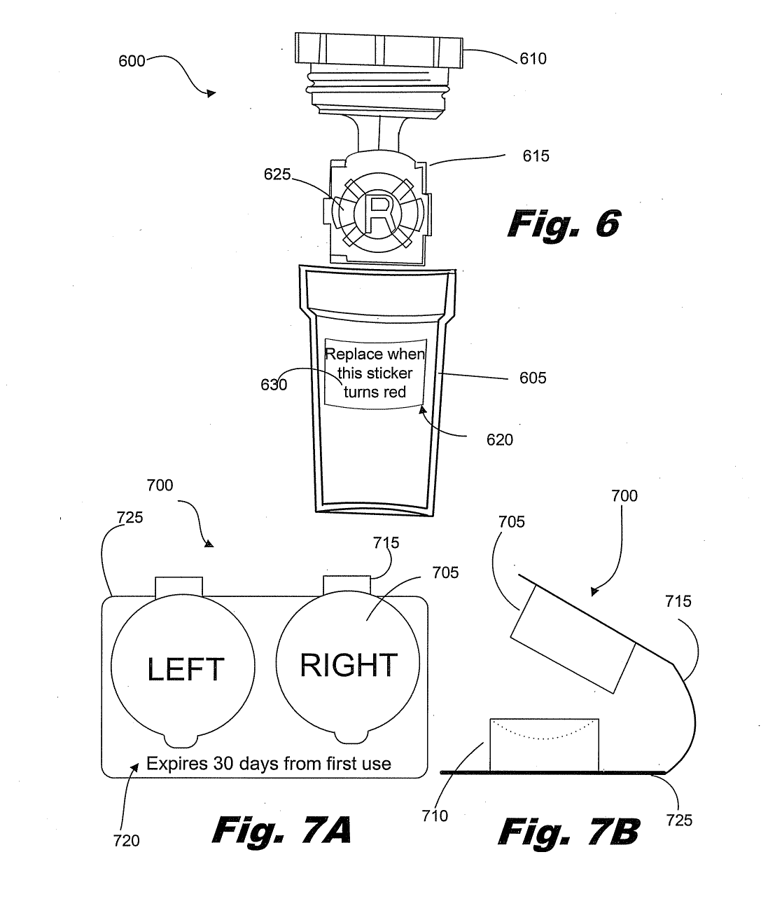

FIG. 6 illustrates another exemplary embodiment of the present secondary contact lens case. According to the exemplary embodiment illustrated in FIG. 6, the secondary contact lens case (600) includes a single container (605) with a screw-on cap (610). The contacts can be placed in two closable baskets (625), one on either side of the contact holder (615) which is attached to the underside of the cap (640). In this exemplary embodiment, the indicator (630) can be placed on either the side of the container (605) or on the cap (610). While any of the above-mentioned indicators may be incorporated into the configuration of FIG. 6, the exemplary indicator (630) illustrated in FIG. 6 includes a sticker (620) that is printed, sprayed, or otherwise coated with a time-sensitive ink. According to one exemplary embodiment, the time-sensitive ink may be configured to change its appearance or color after being activated due to exposure to air, water, or another initiator. According to one exemplary embodiment, a time sensitive ink may be applied to the secondary contact lens case (600) directly during the manufacture of the secondary contact lens case (600). Alternatively, the time sensitive ink may be applied to the secondary contact lens case (600) post manufacture by spray, roller, an adhesive, or any other acceptable application method.

According to this exemplary embodiment, when the secondary contact lens case (600) is opened, filled with solution, or otherwise accessed by a user, the time sensitive ink is initiated (either by exposure to the air or by exposure to water, saline, or some other initiator substance). Once initiated, the time sensitive ink may change its color characteristics to indicate the life cycle of the secondary contact lens case. For example, the time sensitive ink may be displayed as blue or green when the case is initially accessed by the user and initiated. However, after approximately 30 days, the initiated time sensitive ink may appear red, brown, black, or another color to the user indicating that the secondary contact lens case (600) has expired. A reference color may also be utilized in such a way so that when the time sensitive ink becomes the same shade as the reference color, the user will know that the secondary contact lens case should be replaced.

According to one exemplary embodiment, the time sensitive ink may be acquired from a commercially available source such as, but in no way limited to, Ciba Specialty Chemicals. Additionally, similar to the disclosure made above, the time sensitive ink may be applied to the secondary contact lens case (600) by a secondary or post manufacturing operation, such as by the application of a sticker (620), etc. The use of the time sensitive ink is in no way restricted to the embodiment depicted in FIG. 6, but may be utilized on any secondary contact lens case (600).

FIGS. 7A and 7B illustrate yet another exemplary embodiment of the present secondary contact lens case (700) including an expiration indicator (720). In the exemplary embodiment of FIGS. 7A and 7B, the secondary contact lens case (700) includes a substantially flat base (725) that extends beyond a plurality of separate bottom members (710). Two caps (705) are attached to the base (725) by a flexible strap (715) and may attach to the bottom members (710) with a snap-on fit. In this embodiment the phrase, “Expires 30 days from first use” (720) is molded directly to the top of the base (725). As discussed above, this indicator (720) could also be comprised of a number, letter, shape, color, word, date, or other method of communication designed to apprise the user of the intended length of time the case should be used or the intended replacement date. This indicator (720) may be placed anywhere on the case (700) provided that the indicator (720) is visible and apparent to the user.

As discussed, the expiration indicators (720) may be formed or otherwise coupled to the secondary contact lens case using any number of methods. For example, according to one exemplary embodiment, the expiration indicator may be formed or molded on one or more of the hermetic caps (705); may be molded on the top or bottom of the base (725); may be molded inversely on the bottom of the base (725), where the base (725) is substantially transparent; may be formed on the secondary contact lens case (700) using a two-shot mold process, wherein the secondary contact lens case (700) is molded in a first instance from a first shot and the expiration indicator (720) is formed from a second shot. According to this exemplary embodiment, the second shot may form the expiration indicator (720) from any number of materials including, but not limited to a material that provides color or contrast against the material from the first shot. This will assure that the user commonly notices the reminder that the secondary contact lens case (700) has a limited useful life. Additionally, the expiration indicator may be formed on the secondary contact lens case (700) by the selective application of paint, ink from a printing device, a dye, the application of a sticker, and the like.

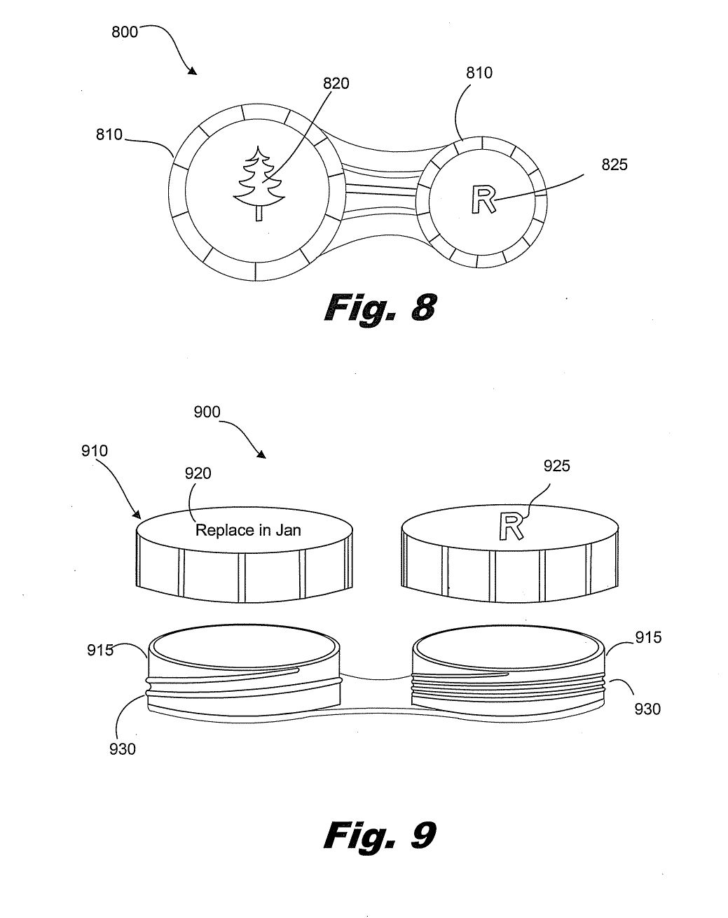

FIG. 8 illustrates another exemplary embodiment in which a symbol (820) or a picture is placed on one of the caps (810) of a secondary contact lens case (800) to provide a reminder to the user to frequently dispose of the secondary contact lens case. In the exemplary embodiment of FIG. 8, any number of symbols or pictures may be used to remind a user to dispose of their secondary contact lens storage case (800) frequently, such as monthly. For example, according to this exemplary embodiment, the indicators may include, but are in no way limited to, pictures or shapes related to the various seasons or holidays such as snowmen, snowflakes, presents, Christmas trees, dreidels, etc. for winter, fall leaves, turkeys, jack-o-lanterns, footballs, etc. for fall, flowers, hearts, shamrocks, raindrops, kites, etc. for spring, sunshine, fire-crackers, etc. for summer.

Additionally, as illustrated in FIG. 8, the caps (810) of the secondary contact lens case (800) includes both caps (810) and bottom members (not shown) having unique or different sizes. As mentioned previously, the eye indicator (825) as used on traditional secondary contact lens case caps can be removed from at least one cap (810) to make room for an expiration indicator (820). While one left or right side indicator (825) on the caps (810) is sufficient to inform a user of the proper orientation and placement of a contact lens in the secondary contact lens case (800), further precautions may be incorporated into the design of the secondary contact lens case (800) to assure proper placement. For example, as illustrated in FIG. 8, the size of the first and second bottom members (not shown) and the corresponding caps (810) may be different, assuring that the proper cap (810) is consistently provided to the correct bottom member (not shown). This ensures that the correct contact lens will be placed in the appropriate well and eliminate the issues that may be caused when lids on a secondary contact lens case (800) are accidentally switched.

Similarly, FIG. 9 illustrates an exemplary embodiment of a secondary contact lens case (900) that incorporates threads (930) of a differing pitch and/or gap to fulfill the function of assuring correct lens and cap (910) placement. According to the exemplary embodiment illustrated in FIG. 9, the cap (910) includes corresponding threads to fit the proper well. In either the embodiment illustrated in FIG. 8 or the exemplary embodiment illustrated in FIG. 9, the caps (910) will only fit on their corresponding bottom member (915) which aids the user in maintaining orientation and lens placement. The indicator (920) illustrated in FIG. 9 includes a message that reminds the user to replace the secondary contact case in Jan. However, as discussed previously, the indicator (920) could also be comprised of any number of different methods of communicating a reminder to the user.

Furthermore, the application of an expiration indicator allows for individual packaging or a grouping of secondary contact lens cases (900) in groups of three intended to last for a quarter of a year, groups of six to last for a half of a year, or groups of 12 configured to last a user for an entire year. Alternative groupings may also be used.

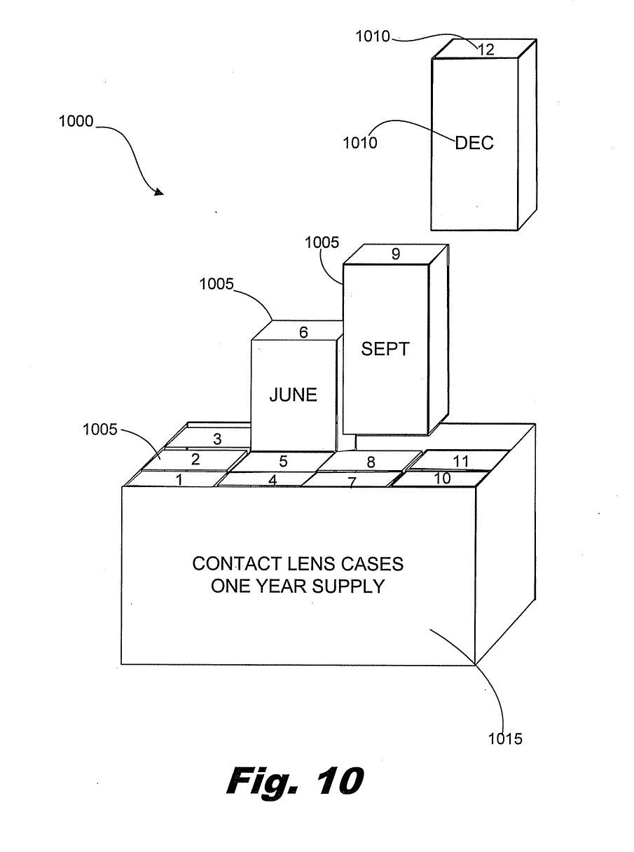

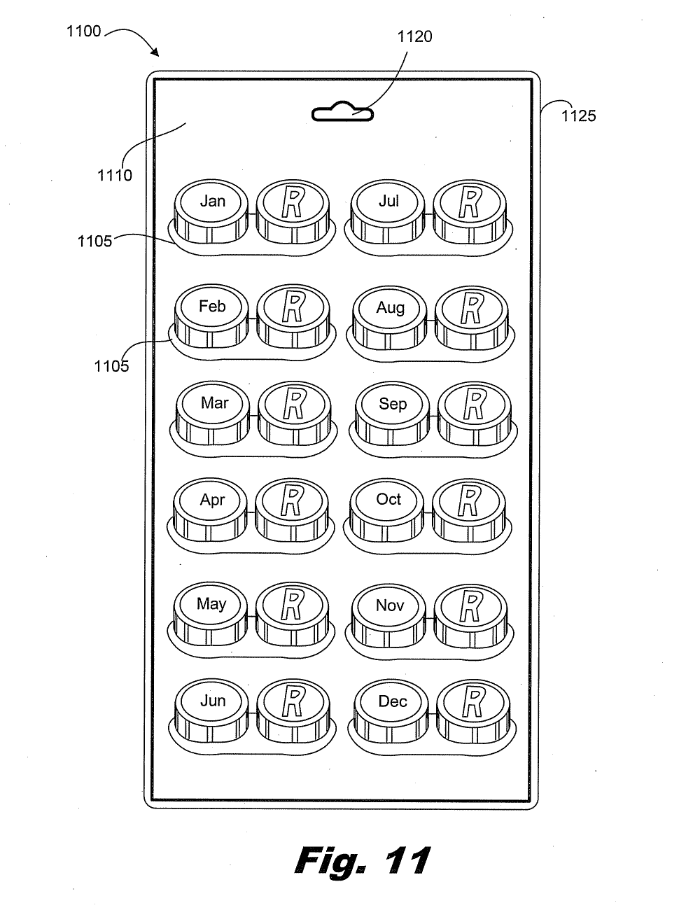

FIGS. 10 and 11 illustrate two methods for generating group packaging of the present secondary contact lens cases, according to various exemplary embodiments. For example, as illustrated in FIG. 10, a box (1015) containing twelve individually packaged and marked secondary contact lens cases (1005) is illustrated. As shown, each of the individual packages (1005) are sealed in such a way as to ensure that the case is kept uncontaminated. Additionally, they may be sealed such that when the seal is broken, the case inside is exposed to air, triggering the start of the time sensitive ink's progression. According to the exemplary embodiment, twelve of the exemplary packages (1005) could fit in a box (1015) approximately 4″×4″×8″.

Similarly, FIG. 11 illustrates an alternative exemplary embodiment of the group packaging (1100) of twelve of the secondary lens cases (1105). As illustrated in FIG. 9, a plurality of secondary contact lens cases (1105) can be mounted on a sheet of cardboard or other substrate (1110). Zip-ties, twist-ties or other fasteners may be used to hold the cases in place, or alternatively, a formed clear plastic protector may encase the entire package (1125), keeping the cases in place. According to one exemplary embodiment, the formed clear plastic protector (1125) may provide either an individual or a general hermetic seal around the perimeter of plurality of secondary contact lens cases (1105). The package (1100) may also have a void or hole (1120) near the top in order to allow the package (1100) to be hung in stores. According to one exemplary embodiment, the providing of a year supply of secondary contact lens cases (1105) would encourage a user to frequently dispose of the secondary contact lens cases (1105).

In conclusion, the present exemplary system and method provide an expiration indicator on a secondary contact lens case. The inclusion of an expiration indicator reminds users that the secondary contact lens case has a useful life and should be disposed of frequently. Consequently, proper disposal of the secondary contact lens cases and general optical health and lens comfort will be enhanced.

The preceding description has been presented only to illustrate and describe embodiments of the exemplary systems and methods. It is not intended to be exhaustive or to limit the systems and methods to any precise form disclosed. Many modifications and variations are possible in light of the above teaching.

What is claimed is:

1. A secondary contact lens case comprising an indicator on said secondary case, wherein said indicator is configured to indicate when said secondary contact lens case expires.

2. The secondary contact lens case of claim 1, wherein said indicator comprises a month indicator.

3. The secondary contact lens case of claim 1, wherein said indicator comprises a picture related to a month or a season.

4. The secondary contact lens case of claim 1, wherein said indicator comprises a shape.

5. The secondary contact lens case of claim 1, wherein said indicator comprises a color.

6. The secondary contact lens case of claim 1, wherein said indicator comprises a date.

7. The secondary contact lens case of claim 1, wherein said indicator comprises a time period.

8. The secondary contact lens case of claim 1, wherein said indicator comprises an expiration notice.

9. The secondary contact lens case of claim 1, wherein said indicator comprises a reactive ink that changes colors after a designated amount of exposure to an initiator.

10. The secondary contact lens case of claim 9, wherein said initiator comprises at least one of air, water, heat, or light.

11. The secondary contact lens case of claim 1, wherein said indicator is formed as an integral part of said secondary case.

12. The secondary contact lens case of claim 1, wherein said indicator is applied to said secondary case after said secondary case is formed.

13. The secondary contact lens case of claim 1, wherein said case further comprises at least one cap; wherein said indicator is disposed on said cap.

14. The secondary contact lens case of claim 1, wherein said case further comprises a base, wherein said indicator is located on said base.

15. The secondary contact lens case of claim 1, wherein said case further comprises at least one well, wherein said indicator is located on said well.

16. The secondary contact lens case of claim 1, wherein said case further comprises first and second bottom members and corresponding caps.

17. The secondary contact lens case of claim 16, wherein said first and second bottom members further comprise at least one of substantially different geometries, sizes, or physical appearances.

18. The secondary contact lens case of claim 16, wherein each of said first and second bottom members further comprises threading complementary to said corresponding caps.

19. The secondary contact lens case of claim 18, wherein said complementary threads of said first and second bottom members comprise at least one of substantially different sizes, pitches, or gaps.

20. A secondary contact lens case comprising:
at least one bottom member having a well, and a wall rising above said well and ending in a top rim defining an opening;
a base configured to stabilize said case;
one or more caps, corresponding to said at leas one bottom member and configured to completely cover said top rim; and so as to provide a leak-proof enclosure;
an indicator on said case configured to indicate when said secondary contact lens case expires.

21. The secondary contact lens case of claim 20, wherein said indicator is located on said cap.

22. The secondary contact lens case of claim 20, wherein said indicator is located on said base.

23. The secondary contact lens case of claim 20, wherein said indicator is located underneath said well.

24. The secondary contact lens case of claim 20, wherein said cap is configured to provide a leak-proof enclosure.

25. The secondary contact lens case of claim 20, wherein said case comprises at least two of said bottom members.

26. The secondary contact lens case of claim 25, wherein said bottom members are different in size or shape.

27. The secondary contact lens case of claim 25, wherein said bottom members and caps further comprise complementary threading.

28. The secondary contact lens case of claim 27, wherein said bottom members' threads are substantially different in size, pitch, or gap.

29. A method of fabricating a secondary contact lens case comprising:
forming a secondary contact lens case;
wherein said case includes an expiration indicator.

30. The method of claim 29, wherein said indicator is integrally formed or molded on the surface of said case during a manufacturing process.

31. The method of claim 29, wherein said indicator is formed on said case post manufacture.

32. The method of claim 29, wherein said indicator is formed by a process selected from the group of inkjet printing, laser printing, single shot molding, application of a sticker, or any combination thereof.

33. The method of claim 29, wherein said indicator is formed by a two shot process.

34. The method of claim 33, wherein a second shot forms the indicator from a second material that provides color or contrast against a first material from a first shot.

35. The method of claim 29, wherein said case further comprises a substantially transparent base.

36. The method of claim 35, wherein said indicator is formed in reverse on a bottom of said base.
